(19) United States
(12) Patent Application Publication
(10) Pub. No.: US 2025/0018910 A1
(43) Pub. Date: Jan. 16, 2025

(54) FLUID PRESSURE CONTROL DEVICE

(71) Applicant: ADVICS CO., LTD., Kariya-shi, Aichi-ken (JP)

(72) Inventor: Emiko OZAWA, Kariya-shi, Aichi-ken (JP)

(73) Assignee: ADVICS CO., LTD., Kariya-shi, Aichi-ken (JP)

(21) Appl. No.: 18/713,433

(22) PCT Filed: Nov. 29, 2022
(86) PCT No.: PCT/JP2022/043853

§ 371 Date: May 24, 2024

(30) Foreign Application Priority Data
Nov. 30, 2021 (JP) 2021-194392

(51) Int. Cl. B60T 8/36; H02K 5/22

(52) U.S. Cl. CPC B60T 8/368; H02K 5/225

(57) ABSTRACT

A fluid pressure control device includes a motor to drive a pump; a housing having an outer surface, and a first hole that opens in a first surface of the outer surface which faces the motor. The first hole accommodates the pump, and two second holes open in the outer surface. The two second holes are spaced apart in a first direction; and a current supply unit that allows current for driving the motor to flow passes through the housing. A through hole opens in the first surface and a second surface which is opposite to the first surface of the outer surface. The through hole has a first part located between the two second holes, and a width of the first part in the first direction is smaller than a width of the first part in a second direction along the second surface and orthogonal to the first direction.

### TECHNICAL FIELD

An embodiment of the present disclosure relates to a fluid pressure control device.

### BACKGROUND ART

In the related art, a fluid pressure control device that adjusts pressure in a fluid path of a brake device is known. The fluid pressure control device includes, for example, a housing provided with a fluid path and a plurality of holes. Various components such as a pump and an electromagnetic valve are mounted in the plurality of holes. Further, a terminal extending from a motor that drives a pump is connected to a control board through a through hole provided in the housing (PTL 1).

### CITATION LIST

### Patent Literature

PTL 1: JP2010-006367A

### SUMMARY

### Technical Problem

However, when there are a large number of terminals or when the terminal is large in the configuration in the related art, the through hole becomes large. Therefore, when a predetermined distance is provided between the through hole and another hole, a size of the housing increases.

The disclosure has been made in view of the above circumstances, and provides a fluid pressure control device capable of preventing an increase in a size of a housing.

### Solution to Problem

For example, a fluid pressure control device according to an embodiment of the disclosure includes: a pump; a motor configured to drive the pump; a housing having an outer surface, a first hole that opens in a first surface of the outer surface which faces the motor, the first hole accommodating the pump, and two second holes that open in the outer surface and are separated from the first hole, the two second holes being arranged at an interval in a first direction; and a current supply unit allowing a current for driving the motor to flow and passing through the housing and a through hole opened in the first surface and a second surface which is opposite to the first surface of the outer surface, in which the through hole has a first part located between the two second holes, and a width of the first part in the first direction is smaller than a width of the first part in a second direction along the second surface and orthogonal to the first direction. Therefore, for example, the fluid pressure control device can increase the number of a plurality of conductors of the current supply unit and increase an interval between the plurality of conductors without increasing a width of the through hole in the first direction. Accordingly, the fluid pressure control device can prevent an increase in a distance between the two second holes. In addition, the second hole can be disposed closer to the first hole as compared with a case where the through hole is disposed between the first hole and the second hole. For the above reasons and the like, the fluid pressure control device can prevent an increase in a size of the housing.

### BRIEF DESCRIPTION OF DRAWINGS

FIG. 1 is a cross-sectional view schematically showing a fluid pressure control device according to a first embodiment.

FIG. 2 is a perspective view showing a housing according to the first embodiment.

FIG. 3 is a front view showing the housing according to the first embodiment.

FIG. 4 is a back view showing the housing according to the first embodiment.

FIG. 5 is a perspective view schematically showing a motor and a harness according to the first embodiment.

FIG. 6 is a cross-sectional view schematically showing the housing, the motor, and the harness according to the first embodiment.

FIG. 7 is an exploded perspective view schematically showing a housing and a harness according to a second embodiment.

### DESCRIPTION OF EMBODIMENTS

### First Embodiment

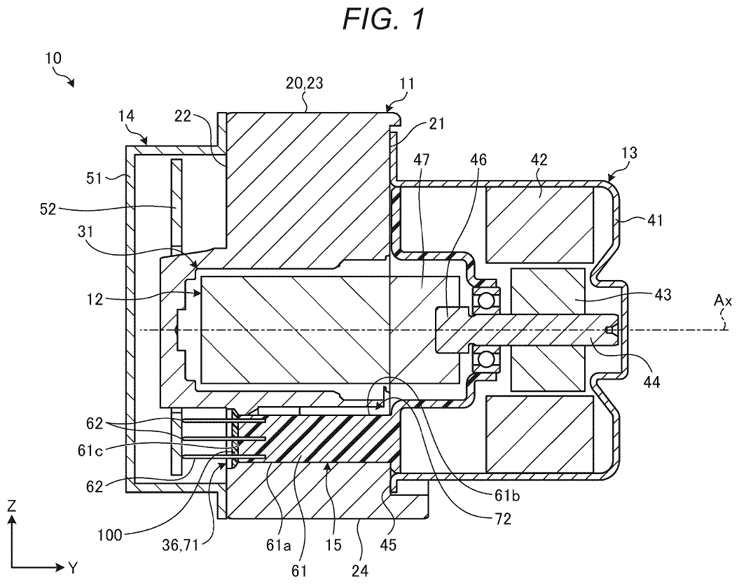

Hereinafter, a first embodiment will be described with reference to FIGS. 1 to 6. In the present specification, basically, a vertically upward direction is defined as an up direction, and a vertically downward direction is defined as a down direction. In the present specification, a component according to an embodiment and description of the component may be described in multiple expressions. A component and description thereof are merely examples, and are not limited to expressions in the present specification. A component may be identified by a name different from that described in the present specification. A component may be described by an expression different from an expression in the present specification.

FIG. 1 is a cross-sectional view schematically showing a fluid pressure control device 10 according to the first embodiment. The fluid pressure control device 10 is mounted on a vehicle such as an automated vehicle. The fluid pressure control device 10 adjusts pressure (fluid pressure) in a fluid path of a brake device of the vehicle. The fluid pressure control device 10 is not limited to this example.

As shown in the drawings, an X axis, a Y axis, and a Z axis are defined for convenience in the present specification. The X axis, the Y axis, and the Z axis are orthogonal to one another. The X axis is provided along a width of the fluid pressure control device 10. The Y axis is provided along a thickness of the fluid pressure control device 10. The Z axis is provided along a height of the fluid pressure control device 10.

Further, an X direction, a Y direction, and a Z direction are defined in the present specification. The X direction is a direction along the X axis and includes a +X direction indicated by an arrow of the X axis and a −X direction opposite to the direction indicated by the arrow of the X axis. The Y direction is a direction along the Y axis and includes a +Y direction indicated by an arrow of the Y axis and a −Y direction opposite to the direction indicated by the arrow of the Y axis. The Z direction is a direction along the Z axis and includes a +Z direction (the up direction) indicated by an arrow of the Z axis and a −Z direction (the down direction) opposite to the direction indicated by the arrow of the Z axis.

The fluid pressure control device 10 includes a housing 11, a pump 12, a motor 13, an electronic control unit (ECU) 14, and a harness 15. The harness 15 is an example of a current supply unit.

The housing 11 is, for example, a substantially rectangular parallelepiped block made of metal or synthetic resin. The housing 11 is not limited to this example. The pump 12, the motor 13, the ECU 14, and the harness 15 are attached to the housing 11.

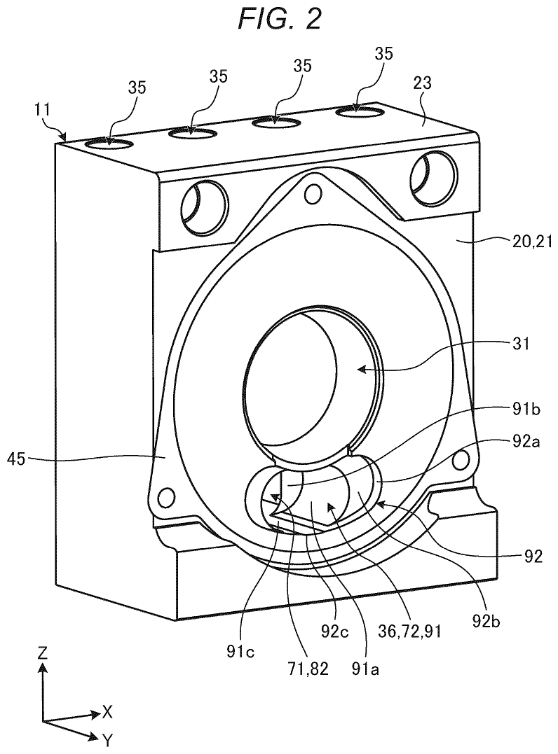

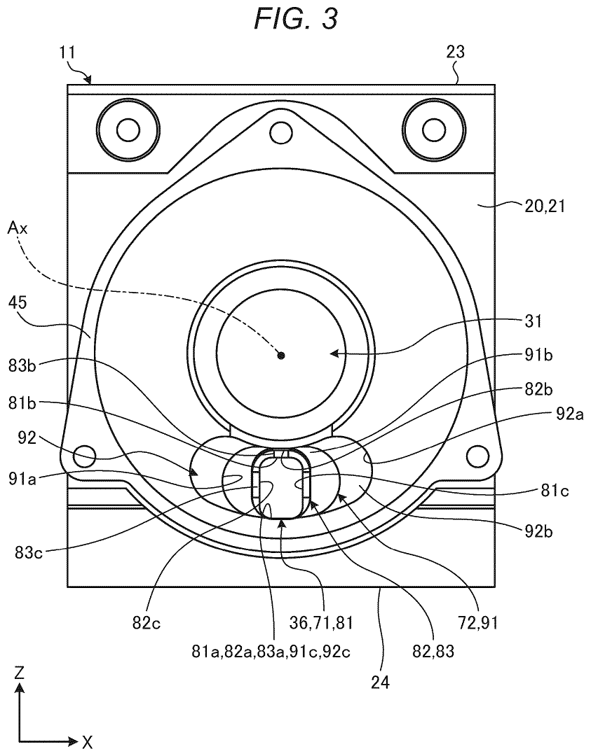

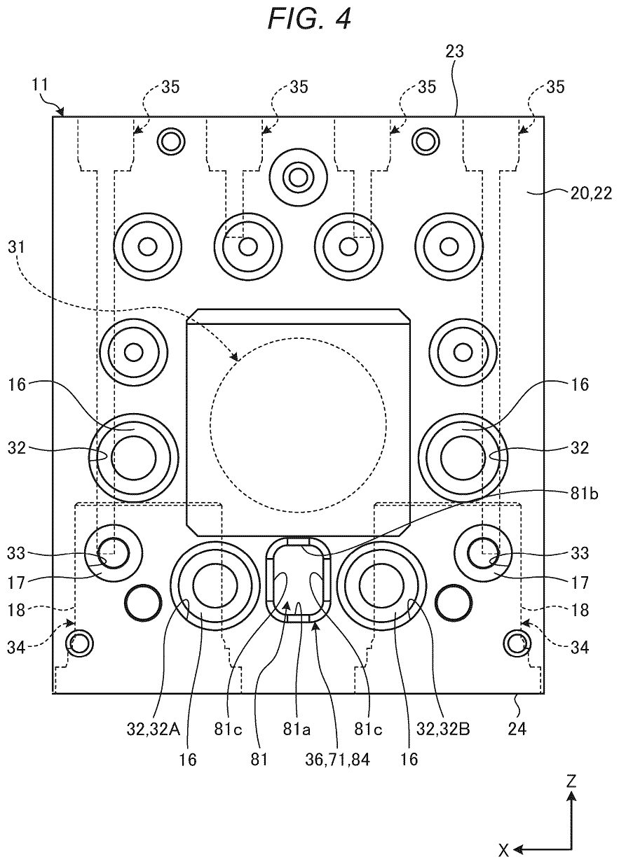

FIG. 2 is a perspective view showing the housing 11 according to the first embodiment. FIG. 3 is a front view showing the housing 11 according to the first embodiment. FIG. 4 is a back view showing the housing 11 according to the first embodiment.

As shown in FIG. 4, the fluid pressure control device 10 further includes a plurality of electromagnetic valves 16, a plurality of pressure sensors 17, and a plurality of reservoirs 18. The electromagnetic valves 16, the pressure sensors 17, and the reservoirs 18 are also attached to the housing 11.

The housing 11 has an outer surface 20. The outer surface 20 is a surface of the housing 11 facing the outside of the housing 11. The outer surface 20 has a first mounting surface 21 in FIG. 3, a second mounting surface 22 in FIG. 4, an upper surface 23, and a lower surface 24. The first mounting surface 21 is an example of a first surface. The second mounting surface 22 is an example of a second surface.

As shown in FIG. 1, the first mounting surface 21 is formed substantially flat and faces the +Y direction. The second mounting surface 22 is located opposite to the first mounting surface 21. The second mounting surface 22 is formed substantially flat and faces the −Y direction. The upper surface 23 is formed substantially flat and faces the +Z direction. The lower surface 24 is located opposite to the upper surface 23. The lower surface 24 is formed substantially flat and faces the −Z direction.

As shown in FIG. 4, the housing 11 is provided with a pump mounting hole 31, a plurality of valve mounting holes 32, a plurality of sensor mounting holes 33, a plurality of reservoir mounting holes 34, a plurality of flow paths 35, and a through hole 36. The pump mounting hole 31 is an example of a first hole. Another hole such as a hole used for attachment may be provided in the housing 11.

As shown in FIG. 2, the pump mounting hole 31 opens in the first mounting surface 21. The pump mounting hole 31 is a recessed portion recessed from the first mounting surface 21 substantially in the −Y direction. The pump mounting hole 31 opens in the first mounting surface 21 at substantially a center of the first mounting surface 21.

As shown in FIG. 4, the plurality of valve mounting holes 32 and the plurality of sensor mounting holes 33 open in the second mounting surface 22. The plurality of reservoir mounting holes 34 open in the lower surface 24. The flow paths 35 open in the upper surface 23. That is, the valve mounting holes 32, the sensor mounting holes 33, the reservoir mounting holes 34, and the flow paths 35 open in the outer surface 20.

The valve mounting holes 32 and the sensor mounting holes 33 are recessed portions recessed from the second mounting surface 22 substantially in the +Y direction. The reservoir mounting holes 34 are recessed portions recessed from the lower surface 24 substantially in the +Z direction. The valve mounting holes 32, the sensor mounting holes 33, and the reservoir mounting holes 34 may pass through the housing 11.

The valve mounting holes 32, the sensor mounting holes 33, and the reservoir mounting holes 34 are separated from one another and are also separated from the pump mounting hole 31. The plurality of valve mounting holes 32 and the plurality of sensor mounting holes 33 are arranged apart from one another in a manner of surrounding the pump mounting hole 31. The pump mounting hole 31, the valve mounting holes 32, the sensor mounting holes 33, and the reservoir mounting holes 34 may communicate with one another.

The plurality of valve mounting holes 32 include two valve mounting holes 32A and 32B. The valve mounting holes 32A and 32B are examples of a second hole. The two valve mounting holes 32A and 32B are located below the pump mounting hole 31. The two valve mounting holes 32A and 32B are arranged at an interval in the X direction. The X direction is an example of a first direction.

In the present embodiment, two reservoir mounting holes 34 are provided in the housing 11. The two reservoir mounting holes 34 are separated from each other in the X direction. A distance between the two reservoir mounting holes 34 is longer than a distance between the two valve mounting holes 32A and 32B.

A plurality of the flow paths 35 communicate with a fluid path of a brake device of the vehicle. Each of the plurality of flow paths 35 connects at least corresponding one of the pump mounting hole 31, the valve mounting holes 32, the sensor mounting holes 33, and the reservoir mounting holes 34 to the fluid path of the brake device. The flow path 35 is not limited to this example. Further, a flow path that allows the valve mounting holes 32, the sensor mounting holes 33, and the reservoir mounting holes 34 to communicate with one another may be provided inside the housing 11.

As shown in FIG. 1, the through hole 36 passes through the housing 11 substantially in the Y direction. Therefore, the through hole 36 opens in the first mounting surface 21 and the second mounting surface 22. The Y direction is an example of a through direction. The through hole 36 is located below the pump mounting hole 31. The through hole 36 is separated from the pump mounting hole 31, the valve mounting holes 32, the sensor mounting holes 33, the reservoir mounting holes 34, and the flow paths 35.

The pump 12 is accommodated in the pump mounting hole 31. The pump 12 is, for example, a gear pump. The pump 12 may be a pump of another type. The pump 12 can send hydraulic oil to the fluid path of the brake device through, for example, the flow path 35.

The motor 13 is, for example, a three-phase brushless motor. The motor 13 may be a motor of another type. The motor 13 includes a casing 41, a stator 42, a rotor 43, and a drive shaft 44.

The casing 41 is attached to the first mounting surface 21 of the housing 11 by, for example, screws. Therefore, the first mounting surface 21 faces the motor 13. The casing 41 covers the pump mounting hole 31 and the through hole 36.

A sealing material 45 is provided between the casing 41 and the first mounting surface 21. As shown in FIG. 3, the sealing material 45 surrounds the pump mounting hole 31 and the through hole 36. Therefore, the sealing material 45 liquid-tightly seals a space between the casing 41 and the first mounting surface 21.

As shown in FIG. 1, the stator 42 is located inside the casing 41 and is fixed to the casing 41. The rotor 43 is located inside the stator 42. The rotor 43 is coupled to the drive shaft 44.

When a drive current flows through the stator 42, the rotor 43 and the drive shaft 44 integrally rotate about a central axis Ax. That is, the drive current drives the motor 13. The central axis Ax is, for example, a central axis of the drive shaft 44. The central axis Ax extends substantially in the Y direction.

For example, a gear 46 is provided on the drive shaft 44. For example, a coupling 47 transmits rotation between the gear 46 and a gear of the pump 12. Accordingly, the motor 13 drives the pump 12 by rotating the drive shaft 44. The motor 13 is not limited to this example. The motor 13 may include, for example, an eccentric shaft eccentric from the central axis Ax instead of the gear 46.

The ECU 14 includes a casing 51 and a circuit board 52. The casing 51 is attached to the second mounting surface 22 of the housing 11 by, for example, screws. The circuit board 52 is located between the casing 51 and the second mounting surface 22 and is covered with the casing 51.

The circuit board 52 includes, for example, a board and various electronic components mounted on the board. Further, the circuit board 52 is electrically connected to, for example, the motor 13, the electromagnetic valves 16, and the pressure sensors 17, and controls the entire fluid pressure control device 10.

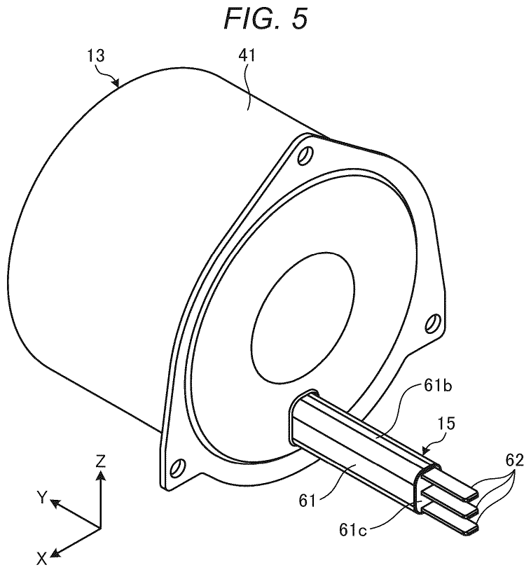

FIG. 5 is a perspective view schematically showing the motor 13 and the harness 15 according to the first embodiment. The harness 15 includes a sleeve 61 and a plurality of terminals 62. The terminal 62 is an example of a conductor.

The sleeve 61 protrudes from the motor 13 substantially in the −Y direction. The sleeve 61 is made of, for example, synthetic resin and has an insulating property. The sleeve 61 may be formed integrally with a portion of the casing 41 of the motor 13 where the casing 41 is made of synthetic resin. The sleeve 61 has predetermined rigidity and can be prevented from being bent by gravity and a predetermined external force. The sleeve 61 covers, for example, a conductive wire connected to the stator 42 of the motor 13. The sleeve 61 has a substantially quadrilateral cross section extending substantially in the Z direction.

As shown in FIG. 1, the sleeve 61 includes a lower surface 61a, an upper surface 61b, and a tip end portion 61c. The lower surface 61a is formed substantially flat and faces substantially the −Z direction. The upper surface 61b is located opposite to the lower surface 61a. The upper surface 61b is formed substantially flat and faces substantially the +Z direction. The tip end portion 61c is an end portion of the sleeve 61 in the −Y direction. A corner portion between the tip end portion 61c and the lower surface 61a and a corner portion between the tip end portion 61c and the upper surface 61b are, for example, R-rounded curved surfaces.

The terminal 62 protrudes from the tip end portion 61c substantially in the −Y direction. The terminal 62 is, for example, a metal plate. The terminal 62 is electrically connected to the stator 42 through a conductive wire covered by the sleeve 61.

In the present embodiment, the harness 15 has three terminals 62. The three terminals 62 are arranged at intervals in the Z direction. The Z direction is a direction along the second mounting surface 22 and is orthogonal to the X direction, and is an example of a second direction and a third direction.

The sleeve 61 extends substantially in the Y direction through the through hole 36. The terminal 62 is electrically connected to the circuit board 52 of the ECU 14. For example, the terminal 62 is connected to a connector of the circuit board 52. The ECU 14 supplies a drive current to the motor 13 through the terminal 62 and a conductive wire covered by the sleeve 61. That is, a drive current for driving the motor 13 flows through the harness 15.

In the present embodiment, the motor 13 does not include a sensor. Therefore, the harness 15 causes a drive current (a drive signal) to flow. Alternatively, the harness 15 may have a conductive wire through which another electric signal such as a detection signal of a sensor flows. The fluid pressure control device 10 may include another harness through which another electric signal flows.

The electromagnetic valve 16 shown in FIG. 4 is, for example, a solenoid valve. The plurality of electromagnetic valves 16 are accommodated in the corresponding valve mounting holes 32. The electromagnetic valve 16 adjusts a flow rate of hydraulic oil flowing through the flow path 35 and the fluid path of the brake device, or changes a path through which the hydraulic oil flows.

The plurality of pressure sensors 17 are accommodated in the corresponding sensor mounting holes 33. The pressure sensor 17 detects fluid pressure in a corresponding flow path. The plurality of reservoirs 18 are accommodated in the corresponding reservoir mounting holes 34. The reservoir 18 can store hydraulic oil.

In the following description, the through hole 36 and the harness 15 will be described in more detail. As shown in FIG. 3, the through hole 36 has a first part 71 and a second part 72. The first part 71 and the second part 72 are parts of the through hole 36 and are arranged in the Y direction.

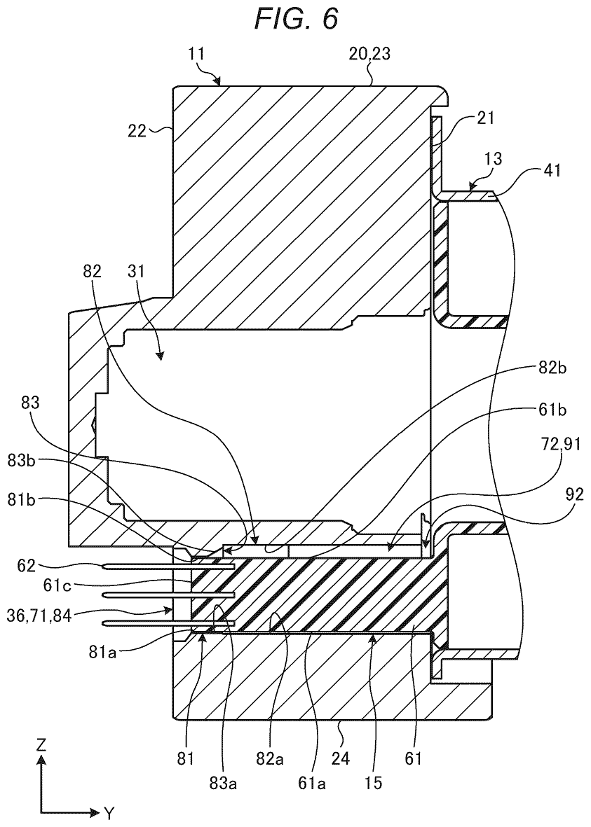

FIG. 6 is a cross-sectional view schematically showing the housing 11, the motor 13, and the harness 15 according to the first embodiment. As shown in FIG. 6, the first part 71 opens in the second mounting surface 22. The first part 71 may be separated from the second mounting surface 22. In this case, the through hole 36 has another portion that is located between the first part 71 and the second mounting surface 22 and opens in the second mounting surface 22. The second part 72 communicates with the first part 71 and opens in the first mounting surface 21. That is, the first part 71 is provided closer to the second mounting surface 22 than the second part 72 is. The through hole 36 may have another part between the first part 71 and the second part 72.

The first part 71 has a minimum portion 81, an inner portion 82, a tapered portion 83, and an outer portion 84. The minimum portion 81 is an example of a first portion. The inner portion 82 is an example of a second portion. The minimum portion 81, the inner portion 82, the tapered portion 83, and the outer portion 84 are portions of the first part 71 and are arranged in the Y direction. In other words, the minimum portion 81, the inner portion 82, and the tapered portion 83 are arranged side by side in the Y direction. The tapered portion 83 of the first part 71 may be omitted.

The minimum portion 81 is a portion having a smallest passage area in the first part 71. A passage area of the through hole 36 including the first part 71 is an area of a cross section of the through hole 36 orthogonal to the Y direction in which the through hole 36 extends.

As shown in FIG. 4, a cross section of the minimum portion 81 has a shape substantially similar to a cross section of the sleeve 61. A passage area of the minimum portion 81 is slightly larger than a cross section area of the sleeve 61. That is, the cross section of the minimum portion 81 is formed in a substantially quadrilateral shape extending substantially in the Z direction. Therefore, the sleeve 61 can pass through the minimum portion 81 and can be fitted to the minimum portion 81. The passage area of the minimum portion 81 is substantially constant.

An inner surface of the minimum portion 81 has a lower surface 81a, an upper surface 81b, and two side surfaces 81c. The lower surface 81a is an example of a third surface. The upper surface 81b is an example of a fourth surface. The inner surface of the minimum portion 81 may further has corner portions coupling the lower surface 81a, the upper surface 81b, and the side surfaces 81c.

The lower surface 81a is formed substantially flat and faces substantially the +Z direction. The upper surface 81b is separated from the lower surface 81a in the +Z direction which is a direction in which the lower surface 81a faces. The upper surface 81b is formed substantially flat and faces substantially the −Z direction. Therefore, the upper surface 81b faces the lower surface 81a and is closer to the pump mounting hole 31 than the lower surface 81a is. The side surface 81c is formed substantially flat and faces substantially the X direction. The side surface 81c connects an end portion of the lower surface 81a and an end portion of the upper surface 81b.

As shown in FIGS. 3 and 4, cross sections of the inner portion 82, the tapered portion 83, and the outer portion 84 are formed in a substantially quadrilateral shape extending substantially in the Z direction. The cross sections of the inner portion 82, the tapered portion 83, and the outer portion 84 may not be similar to the cross section of the minimum portion 81. The cross sections of the inner portion 82, the tapered portion 83, and the outer portion 84 may have other shapes such as an elliptical shape.

As shown in FIG. 6, the inner portion 82 is closer to the first mounting surface 21 than the minimum portion 81 is. The inner portion 82 is coupled to the second part 72. A passage area of the inner portion 82 is larger than a passage area of the minimum portion 81. The passage area of the inner portion 82 is substantially constant.

As shown in FIG. 3, an inner surface of the inner portion 82 has a lower surface 82a, an upper surface 82b, and two side surfaces 82c. The lower surface 82a is an example of a fifth surface. The upper surface 82b is an example of a sixth surface. The inner surface of the inner portion 82 may further include corner portions coupling the lower surface 82a, the upper surface 82b, and the side surfaces 82c.

The lower surface 82a is formed substantially flat and faces substantially the +Z direction. The upper surface 82b is separated from the lower surface 82a in the +Z direction. The upper surface 82b is formed substantially flat and faces substantially the −Z direction. Therefore, the upper surface 82b faces the lower surface 82a and is closer to the pump mounting hole 31 than the lower surface 82a is. The side surface 82c is formed substantially flat and faces substantially the X direction. The side surface 82c couples an end portion of the lower surface 82a and an end portion of the upper surface 82b.

In the present embodiment, a center of the minimum portion 81 is farther from the pump mounting hole 31 than a center of the inner portion 82 is. In other words, the minimum portion 81 is biased relative to the inner portion 82. Therefore, in the Z direction, a distance between the lower surface 81a of the minimum portion 81 and the lower surface 82a of the inner portion 82 is shorter than a distance between the upper surface 81b of the minimum portion 81 and the upper surface 82b of the inner portion 82. In other words, a step between the minimum portion 81 and the inner portion 82 is larger on a side close to the pump mounting hole 31 than on an opposite side in the Z direction intersecting the Y direction.

In the present embodiment, there is almost no distance between the lower surface 81a of the minimum portion 81 and the lower surface 82a of the inner portion 82 in the Z direction. In other words, the lower surface 81a of the minimum portion 81 and the lower surface 82a of the inner portion 82 are provided on substantially the same plane.

The tapered portion 83 is provided between the minimum portion 81 and the inner portion 82. The tapered portion 83 is tapered from the inner portion 82 toward the minimum portion 81. In other words, a passage area of the tapered portion 83 decreases from the inner portion 82 toward the minimum portion 81.

An inner surface of the tapered portion 83 has a lower surface 83a, an upper surface 83b, and two side surfaces 83c. The lower surface 83a is an example of a seventh surface. The inner surface of the tapered portion 83 may further include corner portions coupling the lower surface 83a, the upper surface 83b, and the side surfaces 83c.

The lower surface 83a is continuous with the lower surface 81a of the minimum portion 81. Therefore, the lower surface 83a is formed substantially flat and faces substantially the +Z direction. The upper surface 83b is separated from the lower surface 83a in the +Z direction. The upper surface 83b extends obliquely between an end of the upper surface 81b of the minimum portion 81 and an end of the upper surface 82b of the inner portion 82. The side surface 83c extends obliquely between an end of the side surface 81c of the minimum portion 81 and an end of the side surface 82c of the inner portion 82.

As shown in FIG. 6, the outer portion 84 is closer to the second mounting surface 22 than the minimum portion 81 is. The outer portion 84 is coupled to the minimum portion 81 and opens in the second mounting surface 22. A passage area of the outer portion 84 is larger than the passage area of the minimum portion 81. A center of the outer portion 84 and a center of the minimum portion 81 substantially coincide with each other. The arrangement of the outer portion 84 and the minimum portion 81 is not limited to this example.

As described above, the minimum portion 81, the inner portion 82, the tapered portion 83, and the outer portion 84 are formed in a substantially quadrilateral shape extending substantially in the Z direction. Therefore, a width of the first part 71 in the X direction is smaller than a width of the first part 71 in the Z direction.

The lower surfaces 81a, 82a, and 83a and the upper surfaces 81b, 82b, and 83b may also be referred to as short sides or short diameters. The side surfaces 81c, 82c, and 83c may also be referred to as long sides or long diameters. The X direction may also be referred to as a short side direction or a short diameter direction. The Z direction may also be referred to as a long side direction or a long diameter direction.

As shown in FIG. 4, the outer portion 84 of the first part 71 opens in the second mounting surface 22 between the two valve mounting holes 32A and 32B. Therefore, the first part 71 is located between the two valve mounting holes 32A and 32B. The two valve mounting holes 32A and 32B and the first part 71 are arranged side by side at an interval in the X direction.

A distance between the two valve mounting holes 32A and 32B is larger than a width of the first part 71 in the X direction. On the other hand, the distance between the two valve mounting holes 32A and 32B is smaller than a width of the first part 71 in the Z direction.

A minimum distance between the two valve mounting holes 32A and 32B may be smaller than a maximum width of the first part 71 in the X direction. At each position in the Y direction, a distance between the two valve mounting holes 32A and 32B is larger than a width of the first part 71 in the X direction. Therefore, the first part 71 does not communicate with the valve mounting holes 32A and 32B.

As shown in FIG. 6, a length of the minimum portion 81 in the Y direction is smaller than a length of the inner portion 82 in the Y direction and smaller than a length of the tapered portion 83 in the Y direction. The length of the tapered portion 83 in the Y direction is smaller than the length of the inner portion 82 in the Y direction.

As shown in FIG. 3, the second part 72 has a first expanding portion 91 and a second expanding portion 92. The first expanding portion 91 and the second expanding portion 92 are portions of the second part 72 and are arranged in the Y direction.

The first expanding portion 91 is coupled to the inner portion 82 of the first part 71. The first expanding portion 91 is formed in a substantially arc shape extending about the central axis Ax. The shape of the first expanding portion 91 is not limited to this example.

A width of the first expanding portion 91 in the X direction is larger than a width of the first part 71 in the X direction. The width of the first expanding portion 91 in the X direction is at least larger than a width of the inner portion 82 in the X direction. A passage area of the first expanding portion 91 is larger than a passage area of the inner portion 82.

The first expanding portion 91 is located between the two reservoir mounting holes 34. The width of the first expanding portion 91 in the X direction is smaller than a distance between the two reservoir mounting holes 34. Therefore, the first expanding portion 91 does not communicate with the reservoir mounting holes 34.

An inner surface of the first expanding portion 91 has an inner peripheral surface 91a and a bottom surface 91b. The inner peripheral surface 91a is formed in a substantially arcuate tubular shape. The bottom surface 91b is formed substantially flat and faces substantially the +Y direction. The inner portion 82 of the first part 71 opens in the bottom surface 91b. The inner peripheral surface 91a has a flat surface 91c. The flat surface 91c is provided on an end portion of the inner peripheral surface 91a in the −Z direction. The flat surface 91c is formed substantially flat and faces the +Z direction.

The second expanding portion 92 is coupled to the first expanding portion 91 and opens in the first mounting surface 21. The second expanding portion 92 is formed substantially in an arc shape extending about the central axis Ax. The shape of the second expanding portion 92 is not limited to this example. The second expanding portion 92 communicates with the pump mounting hole 31.

A width of the second expanding portion 92 in the X direction is larger than a width of the first expanding portion 91 in the X direction. Therefore, the width of the second part 72 in the X direction is larger than the width of the first part 71 in the X direction. A passage area of the second expanding portion 92 is larger than a passage area of the first expanding portion 91. As shown in FIG. 6, a length of the second expanding portion 92 in the Y direction is smaller than a length of the first expanding portion 91 in the Y direction.

Since the second part 72 has the first expanding portion 91 and the second expanding portion 92, a width of the second part 72 in the X direction increases stepwise toward the first mounting surface 21. The width of the second part 72 in the X direction may gradually increase toward the first mounting surface 21.

As shown in FIG. 2, an inner surface of the second expanding portion 92 has an inner peripheral surface 92a and a bottom surface 92b. The inner peripheral surface 92a is formed in a substantially arcuate tubular shape. The bottom surface 92b is formed substantially flat and faces substantially the +Y direction. The first expanding portion 91 opens in the bottom surface 92b. The inner peripheral surface 92a has a flat surface 92c. The flat surface 92c is provided on an end portion of the inner peripheral surface 92a in the −Z direction. The flat surface 92c is formed substantially flat and faces the +Z direction.

The flat surface 91c of the first expanding portion 91 and the flat surface 92c of the second expanding portion 92 are continuous with each other. Further, in the Z direction, a distance between the lower surface 82a of the inner portion 82 and the flat surface 91c of the first expanding portion 91 is shorter than a distance between the upper surface 81b of the minimum portion 81 and the upper surface 82b of the inner portion 82.

In the present embodiment, there is almost no distance between the lower surface 82a of the inner portion 82 and the flat surface 91c of the first expanding portion 91 in the Z direction. In other words, the lower surface 82a of the inner portion 82 and the flat surface 91c of the first expanding portion 91 are provided substantially on the same plane. Accordingly, the flat surfaces 91c and 92c of the first expanding portion 91 and the second expanding portion 92 are substantially continuous with the lower surfaces 81a, 82a, and 83a of the minimum portion 81, the inner portion 82, and the tapered portion 83.

Hereinafter, a part of a manufacturing method of the fluid pressure control device 10 will be exemplified. The manufacturing method of the fluid pressure control device 10 is not limited to the following method, and other methods may be used. First, the pump 12, the electromagnetic valves 16, the pressure sensors 17, and the reservoirs 18 are attached to the housing 11.

Next, the motor 13 is attached to the housing 11. At this time, the harness 15 protruding from the motor 13 is inserted into the through hole 36. For example, the harness 15 is separated from the inner surface of the through hole 36, and is moved in the −Y direction to a predetermined position.

For example, when the tip end portion 61c of the sleeve 61 reaches the inner portion 82, movements of the motor 13 and the harness 15 are temporarily stopped. Next, the motor 13 and the harness 15 are moved in the −Z direction. Accordingly, the lower surface 61a of the sleeve 61 is brought into contact with the lower surface 82a of the inner portion 82, or is close to the lower surface 82a. Since both the lower surfaces 61a and 82a are flat, the lower surfaces 61a and 82a can stably support each other.

Next, the motor 13 and the harness 15 are moved in the −Y direction again. At this time, the lower surface 82a of the inner portion 82 can guide the lower surface 61a of the sleeve 61. When the tip end portion 61c of the sleeve 61 reaches the tapered portion 83, the inner surface of the tapered portion 83 guides the sleeve 61 toward the minimum portion 81.

The sleeve 61 guided by the inner surface of the tapered portion 83 is fitted into the minimum portion 81. When the casing 41 of the motor 13 comes into contact with the first mounting surface 21, the movements of the motor 13 and the harness 15 are completed. The casing 41 is attached to the first mounting surface 21 by, for example, screws.

The terminal 62 of the harness 15 passes through the outer portion 84 and protrudes outward of the through hole 36. As shown in FIG. 1, for example, a sealing material 100 is supplied to the minimum portion 81 and the outer portion 84. Accordingly, the sealing material 100 liquid-tightly seals a gap between the inner surface of the first part 71 and the harness 15.

Next, the ECU 14 is attached to the housing 11. Accordingly, the terminal 62 of the harness 15 is connected to the circuit board 52 of the ECU 14. Through the above steps, the fluid pressure control device 10 is manufactured.

Hydraulic oil may leak from the pump 12 and the motor 13. In this case, the hydraulic oil flows into the second expanding portion 92 that communicates with the pump mounting hole 31. The fluid pressure control device 10 stores the hydraulic oil in a space between the harness 15 and an inner surface of the through hole 36. The sealing materials 45 and 100 prevent the hydraulic oil from leaking out of the fluid pressure control device 10.

In the fluid pressure control device 10 according to the first embodiment described above, the harness 15 passes through the through hole 36 including the first part 71. Since a current for driving the motor 13 flows through the harness 15, the harness 15 includes a plurality of the terminals 62. Since a relatively large current flows through the terminals 62 to drive the motor 13, a size of the harness 15 is likely to increase and noises are likely to occur. On the other hand, in the present embodiment, a width (a length) of the first part 71 in the X direction in which the two valve mounting holes 32A and 32B are arranged is smaller than a width of the first part 71 in the Z direction along the second mounting surface 22 and orthogonal to the X direction. Therefore, in the fluid pressure control device 10 according to the present embodiment, for example, it is possible to increase the number of the plurality of terminals 62 of the harness 15 and to increase an interval between the plurality of terminals 62 without increasing a width of the through hole 36 in the X direction. Accordingly, the fluid pressure control device 10 can prevent an increase in the distance between the two valve mounting holes 32A and 32B while providing a predetermined distance between and around the plurality of terminals 62. As compared with a case where the through hole 36 is disposed between the pump mounting hole 31 and the valve mounting holes 32A and 32B, the valve mounting holes 32A and 32B can be disposed closer to the pump mounting hole 31. For the above reasons and the like, the fluid pressure control device 10 can prevent an increase in a size of the housing 11.

For example, when the motor is a DC brush motor, the harness has two terminals. Generally, a harness having two terminals has a substantially circular cross section. On the other hand, when the motor is a three-phase brushless motor, the harness has three terminals. When a cross section of the harness having three terminals is formed in a substantially circular shape, the harness is large in the X direction. However, in the present embodiment, a cross section of the harness 15 and a cross section of the first part 71 through which the harness 15 passes are formed in a non-circular shape elongated in the Z direction. Therefore, in the fluid pressure control device 10 according to the present embodiment, an increase in the size of the housing 11 can be prevented even when the motor 13 is a three-phase brushless motor.

In the fluid pressure control device 10 according to the present embodiment, a width of the first part 71 in the X direction does not need to be changed according to the number of the terminals 62 of the harness 15. Therefore, the housing 11 can be used for a plurality of types of fluid pressure control devices 10 having different numbers of terminals 62. Specifically, while the width of the first part 71 in the Z direction is changed according to the number of the terminals 62, the other portions of the housing 11 can be shared by a plurality of types of fluid pressure control devices 10. Accordingly, when a plurality of types of fluid pressure control devices 10 are to be manufactured, the cost of the fluid pressure control device 10 can be reduced using the housing 11.

A distance between the two valve mounting holes 32A and 32B is smaller than a width of the first part 71 in the Z direction. Accordingly, the fluid pressure control device 10 according to the present embodiment can prevent an increase in the size of the housing 11 in the X direction.

The harness 15 includes the plurality of terminals 62 arranged in the Z direction. Accordingly, the fluid pressure control device 10 according to the present embodiment can prevent an increase in the size of the housing 11 in the X direction regardless of the number of the plurality of terminals 62.

The through hole 36 has the second part 72 that opens in the first mounting surface 21 and communicates with the pump mounting hole 31. The first part 71 is provided closer to the second mounting surface 22 than the second part 72 is. A width of the second part 72 in the X direction is larger than a width of the first part 71 in the X direction. That is, the second part 72 is wider than the first part 71 and communicates with the pump mounting hole 31. Therefore, the second part 72 can store oil leaked from the pump 12 accommodated in the pump mounting hole 31 or the motor 13 that drives the pump 12.

A width of the second part 72 in the X direction increases toward the first mounting surface 21. Accordingly, a volume of the second part 72 can be increased while ensuring a distance between the second part 72 and another hole such as the reservoir mounting hole 34.

A width of the second expanding portion 92 in the X direction is larger than a width of the first expanding portion 91 in the X direction. That is, the second part 72 in the X direction increases stepwise toward the first mounting surface 21. Accordingly, the second part 72 can be easily formed by, for example, milling.

The through hole 36 has the minimum portion 81 having a smallest passage area in the first part 71, and the inner portion 82 having a passage area larger than that of the minimum portion 81 and arranged side by side with the minimum portion 81 in the through direction (the Y direction) of the through hole 36. A step between the minimum portion 81 and the inner portion 82 is larger on a side close to the pump mounting hole 31 (a distance between the upper surfaces 81b and 82b) than on an opposite side (a distance between the lower surfaces 81a and 82a) in the Z direction orthogonal to the Y direction. That is, the minimum portion 81 is biased relative to the inner portion 82. For example, the harness 15 is inserted into the through hole 36 along a portion of the inner surface of the through hole 36 on a side opposite to the pump mounting hole 31 in the Z direction orthogonal to the through direction, that is, a portion on a side opposite to a large-step side (a small-step side or a no-step side). Accordingly, when the harness 15 passes between the minimum portion 81 and the inner portion 82, the harness 15 does not ride over a large step, and the fluid pressure control device 10 can prevent the harness 15 from being damaged due to the harness 15 riding on a large step. A passage area of the inner portion 82 is larger than a passage area of the minimum portion 81. In the fluid pressure control device 10, since the inner portion 82 is biased toward the pump mounting hole 31 relative to the minimum portion 81, the inner portion 82 can be provided at a position close to the pump mounting hole 31 by the biased amount, and an increase in the size of the housing 11 can be prevented.

The first part 71 has the tapered portion 83 tapered from the inner portion 82 toward the minimum portion 81. An inner surface of the minimum portion 81 has the flat lower surface 81a and the upper surface 81b that is separated from the lower surface 81a in the Z direction, faces the lower surface 81a, and is closer to the pump mounting hole 31 than the lower surface 81a is. An inner surface of the inner portion 82 has the flat lower surface 82a, and the upper surface 82b that is separated from the lower surface 82a in the Z direction, faces the lower surface 82a, and is closer to the pump mounting hole 31 than the lower surface 82a is. In the Z direction, a distance between the lower surface 81a and the lower surface 82a is shorter than a distance between the upper surface 81b and the upper surface 82b. That is, the minimum portion 81 is biased relative to the inner portion 82. The harness 15 may ride on the inner surface of the tapered portion 83 when the harness 15 passes through the tapered portion 83. However, since the distance between the lower surface 81a and the lower surface 82a in the Z direction is short, a height at which the harness 15 rides on the inner surface of the tapered portion 83 is relatively small. Accordingly, the fluid pressure control device 10 according to the present embodiment can prevent the harness 15 from being damaged due to the harness 15 riding on the inner surface of the tapered portion 83. A passage area of the inner portion 82 is larger than a passage area of the minimum portion 81. In the present embodiment, the inner portion 82 is biased toward the pump mounting hole 31 relative to the minimum portion 81. Therefore, the inner portion 82 is closer to the pump mounting hole 31 as compared with a case where the inner portion 82 is biased toward the outside of the pump mounting hole 31 relative to the minimum portion 81. Accordingly, the fluid pressure control device 10 can prevent an increase in the size of the housing 11 in the Z direction.

The inner surface of the tapered portion 83 has the flat lower surface 83a continuous with the lower surface 81a of the minimum portion 81. Therefore, the fluid pressure control device 10 according to the present embodiment can prevent the harness 15 from riding on the inner surface of the tapered portion 83 when the harness 15 passes through the tapered portion 83. Accordingly, the fluid pressure control device 10 can prevent the harness 15 from being damaged due to the riding of the harness 15.

### Second Embodiment

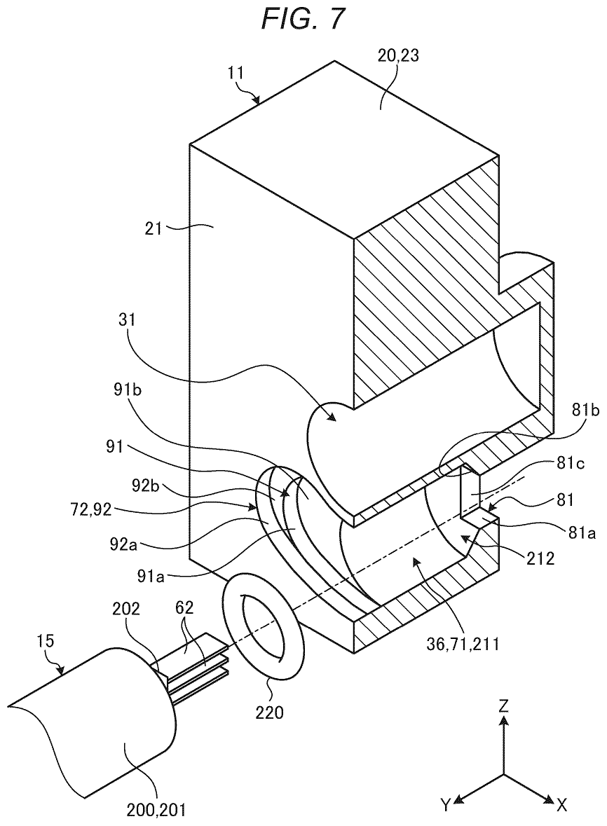

Hereinafter, a second embodiment will be described with reference to FIG. 7. In the following description of the embodiment, components having the same functions as those of components already described are denoted by the same reference numerals as those of the components already described, and further description thereof may be omitted. A plurality of components denoted by the same reference numerals do not necessarily have all common functions and properties, and may have different functions and properties according to embodiments.

FIG. 7 is an exploded perspective view schematically showing the housing 11 and the harness 15 according to the second embodiment. As shown in FIG. 7, the harness 15 according to the second embodiment includes a sleeve 200 instead of the sleeve 61. The sleeve 200 is the similar to the sleeve 61 of the first embodiment except for following points.

The sleeve 200 includes a circular portion 201 and a non-circular portion 202. The circular portion 201 protrudes substantially in the −Y direction from the casing 41 of the motor 13. The circular portion 201 has a substantially circular cross section.

The non-circular portion 202 protrudes substantially in the −Y direction from an end portion of the circular portion 201 in the −Y direction. A cross-section of the non-circular portion 202 is formed in a substantially quadrilateral shape extending substantially in the Z direction, and is substantially similar to the cross section of the minimum portion 81. Similar to the sleeve 61 according to the first embodiment, the non-circular portion 202 includes the lower surface 61a, the upper surface 61b, and the tip end portion 61c.

The first part 71 according to the second embodiment includes an inner portion 211 and a tapered portion 212 instead of the inner portion 82 and the tapered portion 83. The inner portion 211 is the similar to the inner portion 82 according to the first embodiment except for following points. The tapered portion 212 is similar to the tapered portion 83 according to the first embodiment except for following points.

A cross section of the inner portion 211 is formed in a substantially circular shape. A passage area of the inner portion 211 is larger than a passage area of the circular portion 201. The tapered portion 212 is provided between the minimum portion 81 and the inner portion 211. The tapered portion 212 is tapered from the inner portion 211 toward the minimum portion 81. In the second embodiment, a center of the minimum portion 81 and a center of the inner portion 211 substantially coincide with each other.

The fluid pressure control device 10 according to the second embodiment includes an O-ring 220 instead of the sealing material 100. The O-ring 220 is interposed between an end portion of the circular portion 201 in the −Y direction and an inner surface of the tapered portion 212. Accordingly, the O-ring 220 liquid-tightly seals the first part 71.

In the fluid pressure control device 10 according to the second embodiment described above, the inner portion 211 has a circular cross section. The tapered portion 212 is tapered from the inner portion 211 toward the minimum portion 81. The O-ring 220 is interposed between the harness 15 and an inner surface of the tapered portion 212, and seals a gap between the harness 15 and the inner surface of the tapered portion 212. Accordingly, the fluid pressure control device 10 can use the O-ring 220, and a manufacturing process of the fluid pressure control device 10 can be simplified.

In the embodiments described above, cross sections of the harness 15 and the through hole 36 are formed in a substantially quadrilateral shape. However, the cross sections of the harness 15 and the through hole 36 may have another shape that is long in one direction and short in another direction. For example, the cross sections of the harness 15 and the through hole 36 may be formed in an elliptical shape.

For example, a fluid pressure control device according to at least one embodiment described above includes: a pump; a motor configured to drive the pump; a housing having an outer surface, a first hole that opens in a first surface of the outer surface which faces the motor, the first hole accommodating the pump, and two second holes that open in the outer surface and are separated from the first hole, the two second holes being arranged at an interval in a first direction; and a current supply unit allowing a current for driving the motor to flow and passing through the housing and a through hole opened in the first surface and a second surface which is opposite to the first surface of the outer surface, in which the through hole has a first part located between the two second holes, and a width of the first part in the first direction is smaller than a width of the first part in a second direction along the second surface and orthogonal to the first direction. Since a current for driving the motor flows through the current supply unit, the current supply unit generally includes a plurality of conductors. Since a relatively large current flows through the conductors to drive the motor, a size of the current supply unit is likely to increase and noises are likely to occur. On the other hand, in the fluid pressure control device, the width of the first part in the first direction in which the two second holes are arranged is smaller than the width of the first part in the second direction along the second surface and orthogonal to the first direction. Therefore, the fluid pressure control device can, for example, increase the number of the plurality of conductors of the current supply unit and increase an interval between the plurality of conductors without increasing a width of the through hole in the first direction. Accordingly, the fluid pressure control device can prevent an increase in a distance between the two second holes. In addition, the second hole can be disposed closer to the first hole as compared with a case where the through hole is disposed between the first hole and the second hole. For the above reasons and the like, the fluid pressure control device can prevent an increase in a size of the housing.

For example, in the fluid pressure control device, a distance between the two second holes is smaller than a width of the first part in a second direction. Therefore, for example, the fluid pressure control device can prevent an increase in the size of the housing in the first direction.

In the fluid pressure control device, for example, the current supply unit includes a plurality of conductors arranged in the second direction. Therefore, for example, the fluid pressure control device can prevent an increase in the size of the housing in the first direction regardless of the number of the plurality of conductors.

In the fluid pressure control device, for example, the through hole has a second part that opens in the first surface and communicates with the first hole, the first part is closer to the second surface than the second part is, and a width of the second part in the first direction is larger than the width of the first part in the first direction. Therefore, for example, the second part is wider than the first part and communicates with the first hole. Therefore, the second part can store oil leaked from the pump accommodated in the first hole or the motor that drives the pump.

In the fluid pressure control device, for example, the width of the second part in the first direction increases toward the first surface. Therefore, for example, a volume of the second part can be increased while ensuring a distance between the second part and another hole such as the second hole.

In the fluid pressure control device, for example, the first part has a first portion having a smallest passage area in the first part, a second portion closer to the first surface than the first portion is, and a tapered portion tapered from the second portion toward the first portion, an inner surface of the first portion has a flat third surface and a fourth surface that is separated from the third surface in a third direction which is a direction that the third surface faces, the fourth surface facing the third surface and being closer to the first hole than the third surface is, an inner surface of the second portion has a flat fifth surface and a sixth surface that is separated from the fifth surface in the third direction, the sixth surface facing the fifth surface and being closer to the first hole than the fifth surface is, and a distance between the third surface and the fifth surface is shorter than a distance between the fourth surface and the sixth surface in the third direction. Therefore, for example, the first portion is biased relative to the second portion. For example, the current supply unit is inserted into the through hole along the fifth surface. In this case, the current supply unit may ride on the inner surface of the tapered portion when the current supply unit passes through the tapered portion. However, since a distance between the third surface and the fifth surface in the third direction is short, a height at which the current supply unit rides on the inner surface of the tapered portion is relatively small. Accordingly, the fluid pressure control device can prevent the current supply unit from being damaged due to the riding of the current supply unit. A passage area of the second portion is larger than a passage area of the first portion. In the fluid pressure control device, since the second portion is biased toward the first hole relative to the first portion, it is possible to prevent an increase in the size of the housing in the third direction.

In the fluid pressure control device, for example, the inner surface of the tapered portion has a flat seventh surface continuous with the third surface. Therefore, for example, the fluid pressure control device can prevent the current supply unit from riding on the inner surface of the tapered portion when the current supply unit passes through the tapered portion. Accordingly, the fluid pressure control device can prevent the current supply unit from being damaged due to the riding of the current supply unit.

In the fluid pressure control device, for example, the through hole has a first portion having a smallest passage area in the first part and a second portion that is arranged side by side with the first portion in a through direction of the through hole and has a larger passage area than the first portion, and a step between the first portion and the second portion is larger on a side close to the first hole in a direction orthogonal to the through direction than on an opposite side. Therefore, for example, the first portion is biased relative to the second portion. For example, the current supply unit is inserted into the through hole along a portion of an inner peripheral surface of the through hole on a side opposite to the first hole in a direction orthogonal to the through direction, that is, a portion on a side opposite to a large-step side (a small-step side or a no-step side). Accordingly, when the current supply unit passes between the first portion and the second portion, the current supply unit does not ride over a large step, and the fluid pressure control device can prevent the current supply unit from being damaged due to the current supply unit riding on a large step. A passage area of the second portion is larger than a passage area of the first portion. In the fluid pressure control device, since the second portion is biased toward the first hole relative to the first portion, the second portion can be provided at a position close to the first hole by the biased amount, and an increase in the size of the housing can be prevented.

In the above description, prevention is defined as, for example, preventing occurrence of an event, action, or influence, or reducing a degree of an event, action, or influence.

Although embodiments of the disclosure have been described, the embodiments and modifications are presented by way of example only, and are not intended to limit the scope of the disclosure. The above-described embodiments and modifications can be implemented in various other forms, and various omissions, replacements, combinations, and modifications can be made without departing from the gist of the disclosure. A part of configurations and shapes of the embodiments and modifications may be replaced.

1. A fluid pressure control device comprising:
a pump;
a motor configured to drive the pump;
a housing having an outer surface, a first hole that opens in a first surface of the outer surface which faces the motor, the first hole accommodating the pump, and two second holes that open in the outer surface and are separated from the first hole, the two second holes being arranged at an interval in a first direction; and
a current supply unit allowing a current for driving the motor to flow and passing through the housing and a through hole opened in the first surface and a second surface which is opposite to the first surface of the outer surface, wherein
the through hole has a first part located between the two second holes, and
a width of the first part in the first direction is smaller than a width of the first part in a second direction along the second surface and orthogonal to the first direction.

2. The fluid pressure control device according to claim 1, wherein
a distance between the two second holes is smaller than the width of the first part in the second direction.

3. The fluid pressure control device according to claim 2, wherein
the current supply unit includes a plurality of conductors arranged in the second direction.

4. The fluid pressure control device according to claim 3, wherein
the through hole has a second part that opens in the first surface and communicates with the first hole, and the first part is closer to the second surface than the second part is, and
a width of the second part in the first direction is larger than the width of the first part in the first direction.

5. The fluid pressure control device according to claim 4, wherein
the width of the second part in the first direction increases toward the first surface.

6. The fluid pressure control device according to claim 5, wherein
the first part has a first portion having a smallest passage area in the first part, a second portion closer to the first surface than the first portion is, and a tapered portion tapered from the second portion toward the first portion,
an inner surface of the first portion has a flat third surface and a fourth surface that is separated from the third surface in a third direction which is a direction that the third surface faces, the fourth surface facing the third surface and being closer to the first hole than the third surface is,
an inner surface of the second portion has a flat fifth surface and a sixth surface that is separated from the fifth surface in the third direction, the sixth surface facing the fifth surface and being closer to the first hole than the fifth surface is, and
a distance between the third surface and the fifth surface is shorter than a distance between the fourth surface and the sixth surface in the third direction.

7. The fluid pressure control device according to claim 6, wherein
an inner surface of the tapered portion has a flat seventh surface continuous with the third surface.

8. The fluid pressure control device according to claim 5, wherein
the through hole has a first portion having a smallest passage area in the first part and a second portion that is arranged side by side with the first portion in a through direction of the through hole and has a larger passage area than the first portion, and
a step between the first portion and the second portion is larger on a side close to the first hole in a direction orthogonal to the through direction than on an opposite side.

9. The fluid pressure control device according to claim 1, wherein
the current supply unit includes a plurality of conductors arranged in the second direction.

10. The fluid pressure control device according to claim 9, wherein
the through hole has a second part that opens in the first surface and communicates with the first hole, and the first part is closer to the second surface than the second part is, and
a width of the second part in the first direction is larger than the width of the first part in the first direction.

11. The fluid pressure control device according to claim 10, wherein
the width of the second part in the first direction increases toward the first surface.

12. The fluid pressure control device according to claim 11, wherein
the first part has a first portion having a smallest passage area in the first part, a second portion closer to the first surface than the first portion is, and a tapered portion tapered from the second portion toward the first portion,
an inner surface of the first portion has a flat third surface and a fourth surface that is separated from the third surface in a third direction which is a direction that the third surface faces, the fourth surface facing the third surface and being closer to the first hole than the third surface is,
an inner surface of the second portion has a flat fifth surface and a sixth surface that is separated from the fifth surface in the third direction, the sixth surface facing the fifth surface and being closer to the first hole than the fifth surface is, and
a distance between the third surface and the fifth surface is shorter than a distance between the fourth surface and the sixth surface in the third direction.

13. The fluid pressure control device according to claim 12, wherein
an inner surface of the tapered portion has a flat seventh surface continuous with the third surface.

14. The fluid pressure control device according to claim 11, wherein
the through hole has a first portion having a smallest passage area in the first part and a second portion that is arranged side by side with the first portion in a through direction of the through hole and has a larger passage area than the first portion, and
a step between the first portion and the second portion is larger on a side close to the first hole in a direction orthogonal to the through direction than on an opposite side.

15. The fluid pressure control device according to claim 1, wherein
the through hole has a second part that opens in the first surface and communicates with the first hole, and the first part is closer to the second surface than the second part is, and
a width of the second part in the first direction is larger than the width of the first part in the first direction.

16. The fluid pressure control device according to claim 15, wherein
the width of the second part in the first direction increases toward the first surface.

17. The fluid pressure control device according to claim 16, wherein
the through hole has a first portion having a smallest passage area in the first part and a second portion that is arranged side by side with the first portion in a through direction of the through hole and has a larger passage area than the first portion, and
a step between the first portion and the second portion is larger on a side close to the first hole in a direction orthogonal to the through direction than on an opposite side.

18. The fluid pressure control device according to claim 1, wherein
the through hole has a first portion having a smallest passage area in the first part and a second portion that is arranged side by side with the first portion in a through direction of the through hole and has a larger passage area than the first portion, and
a step between the first portion and the second portion is larger on a side close to the first hole in a direction orthogonal to the through direction than on an opposite side.

19. The fluid pressure control device according to claim 1, wherein
the first part has a first portion having a smallest passage area in the first part, a second portion closer to the first surface than the first portion is, and a tapered portion tapered from the second portion toward the first portion,
an inner surface of the first portion has a flat third surface and a fourth surface that is separated from the third surface in a third direction which is a direction that the third surface faces, the fourth surface facing the third surface and being closer to the first hole than the third surface is,
an inner surface of the second portion has a flat fifth surface and a sixth surface that is separated from the fifth surface in the third direction, the sixth surface facing the fifth surface and being closer to the first hole than the fifth surface is, and
a distance between the third surface and the fifth surface is shorter than a distance between the fourth surface and the sixth surface in the third direction.

20. The fluid pressure control device according to claim 19, wherein
an inner surface of the tapered portion has a flat seventh surface continuous with the third surface.
